(19) United States
(12) Patent Application Publication
(10) Pub. No.: US 2026/0144702 A1
(43) Pub. Date: May 28, 2026

(54) CIRCUMFERENTIAL DRIVE MECHANISM FOR MASSAGERS

(71) Applicants: Dongguan Puni Technology Co., Ltd., Dongguan (CN); Shenzhen Taoaisi E-commerce Co., Ltd., Shenzhen (CN)

(72) Inventor: Quesheng Chen, Dongguan (CN)

(21) Appl. No.: 19/032,490

(22) Filed: Jan. 21, 2025

(30) Foreign Application Priority Data
Oct. 15, 2024 (CN) 202422495320.0

(51) Int. Cl. A61H 23/02; A61H 23/00

(52) U.S. Cl. CPC A61H 23/0254; A61H 23/006; A61H 2201/1215

(57) ABSTRACT

The present disclosure discloses a circumferential drive mechanism for a massager, comprising a housing, a drive plate, and a rotating motor, wherein a plurality of massage heads are disposed along a circumference direction of the housing, and the massage heads are slidably installed on the housing, the drive plate is provided with a closed-loop non-circular drive groove, the rear end of massage head is slidably installed in the drive groove, and the rotating motor is connected to the drive plate, and the rear end of drive groove and massage head are in contact with the inner wall of drive groove and drive the massage head to move back and forth. A closed-loop non-circular drive groove enables the drive plate to be a simulated cam structure that can simultaneously drive a plurality of massage heads to move back and forth, thereby simultaneously driving a plurality of massage heads.

### CROSS-REFERENCE TO RELATED APPLICATIONS

This application claims priority to Chinese Patent Application No. 202422495320.0, filed on Oct. 15, 2024, which is hereby incorporated by reference in its entirety.

### TECHNICAL FIELD

The present disclosure relates to the field of massagers, particularly to a circumferential drive movement for massagers.

### BACKGROUND

When driving massage heads to perform reciprocating motion, existing massagers generally achieve the predetermined massage requirements by using a combination of cams and rotating motors. However, when there are two or more massage heads, a more complex fit structure is required to achieve the reciprocating motion of a plurality of massage heads.

Of course, there are also some massage heads that perform reciprocating motion of through the fit between cams and springs, so the structure is correspondingly more complex.

### SUMMARY

The main purpose of the present disclosure is to propose a circumferential drive mechanism for a massager, aiming to improve the structure of the drive mechanism, while simultaneously enabling the reciprocating driving of a plurality of massage heads, and the circumferential drive mechanism for a massager has a simple and stable structure.

To achieve the above objectives, the present disclosure discloses a circumferential drive mechanism for a massager, comprising:
a housing, wherein a plurality of massage heads are disposed along a circumference direction of the housing, and the massage heads are slidably installed on the housing, ;
a drive plate, wherein the drive plate is provided with a closed-loop non-circular drive groove, and the rear end of massage head is slidably installed in the drive groove;
and a rotating motor, wherein the rotating motor is connected to the drive plate, and when the drive plate rotates, the rear end of drive groove and massage head are in contact with the inner wall of drive groove and drive the massage head to move back and forth.

In practical design, a closed-loop non-circular drive groove enables the drive plate to be a simulated cam structure that can simultaneously drive a plurality of massage heads to move back and forth, thereby simultaneously driving a plurality of massage heads, and the simple and stable structure and ingenious design (without springs and other structures) effectively improve the stability of the mechanism.

### BRIEF DESCRIPTION OF DRAWINGS

FIG. 1 is the first exploded view of the present disclosure;

FIG. 2 is the second exploded view of the present disclosure;

FIG. 3 is a sectional view of the present disclosure;

FIG. 4 is a semi sectional schematic diagram of the present disclosure;

FIG. 5 is the first 3D schematic diagram of the present disclosure;

FIG. 6 is the second 3D schematic diagram of the present disclosure;

FIG. 7 is a schematic diagram of the second embodiment of the present disclosure.

Where:
1. Housing, 11 Guide hole,
2. Massage head, 2a. Rod body, 2b. Drive head,
3. Drive plate, 31 Drive groove, 32 Guide groove, 3a. Upper plate, 3b. Lower plate, 3c. First half groove, 3d. Second half groove,
4. Rotating motor,
5. Bracket, 51. Lithium battery.

### DESCRIPTION OF EMBODIMENTS

The technical solutions in the embodiments of the present disclosure will be described clearly and completely in conjunction with the accompanying drawings of the embodiments of the present disclosure. Obviously, the described embodiments are only a part of the embodiments of the present disclosure, rather than all the embodiments. Based on the embodiments of the present disclosure, all other embodiments obtained by those of ordinary skill in the art without creative work shall fall within the protection scope of the present disclosure.

It should be noted that all directional indicators (such as up, down, left, right, front, back, top, bottom, inside, outside, vertical, horizontal, longitudinal, counterclockwise, clockwise, circumferential, radial, axial . . . ) in the embodiments of the present disclosure are only used to explain the relative position relationship and movement among various components in a particular posture (as shown in the accompanying drawings), and if that particular posture is changed, the directional indications will change accordingly.

In addition, descriptions involving terms “first,” “second” and the like, if any, in the present disclosure are only for illustrative purposes and cannot be understood as indicating or implying relative importance or the number of features referred to. Therefore, the features defined with “first” and “second” may explicitly or implicitly include at least one or a plurality of the features. In addition, the technical solutions of various embodiments can be combined with each other, but must be based on the fact that those of ordinary skill in the art can achieve. The combination of technical solutions that result in contradiction or make it impossible to implement should be considered non-existent, and accordingly should not fall within the scope of protection required by the present disclosure.

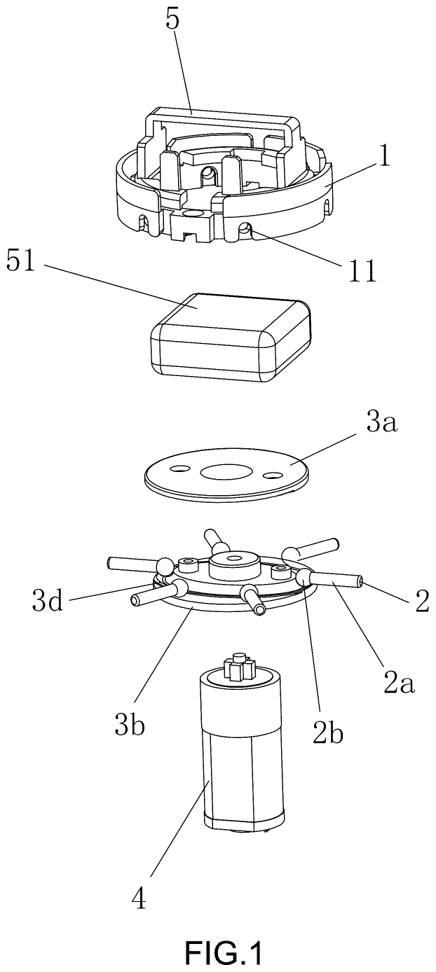

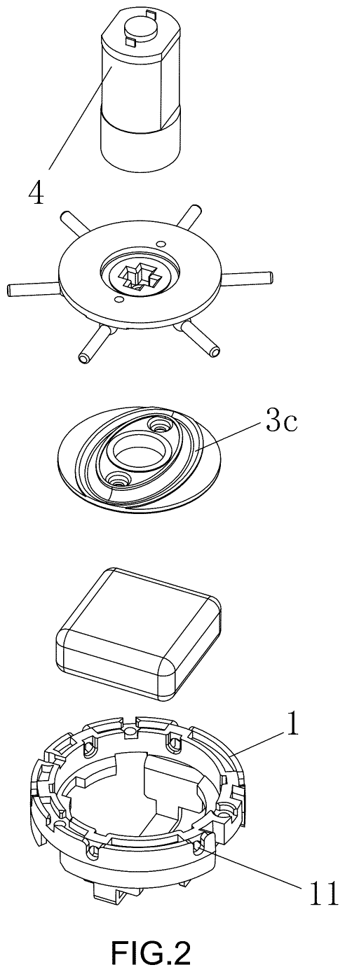

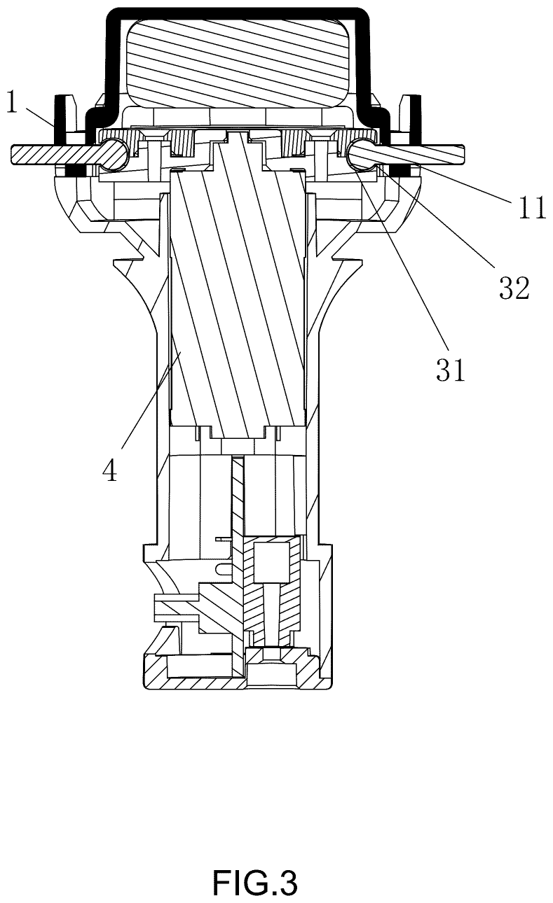

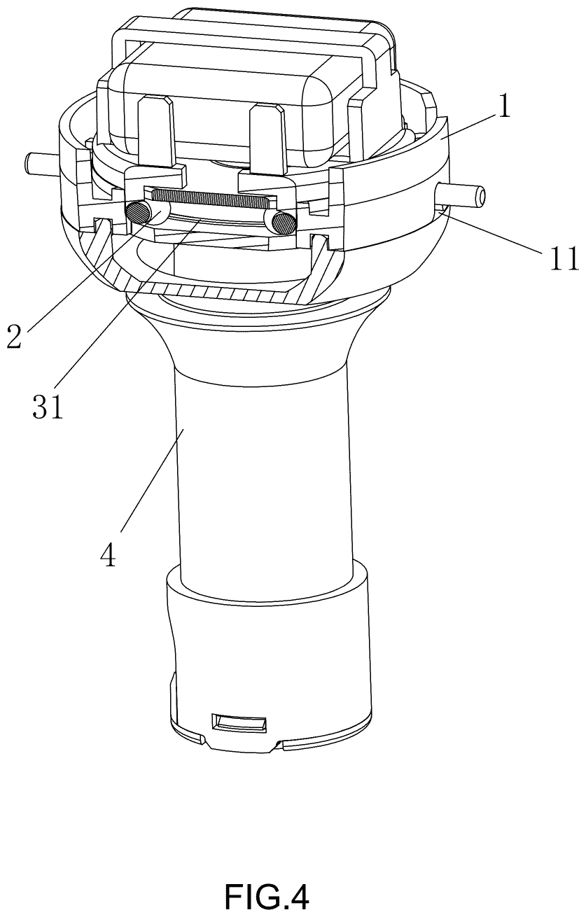

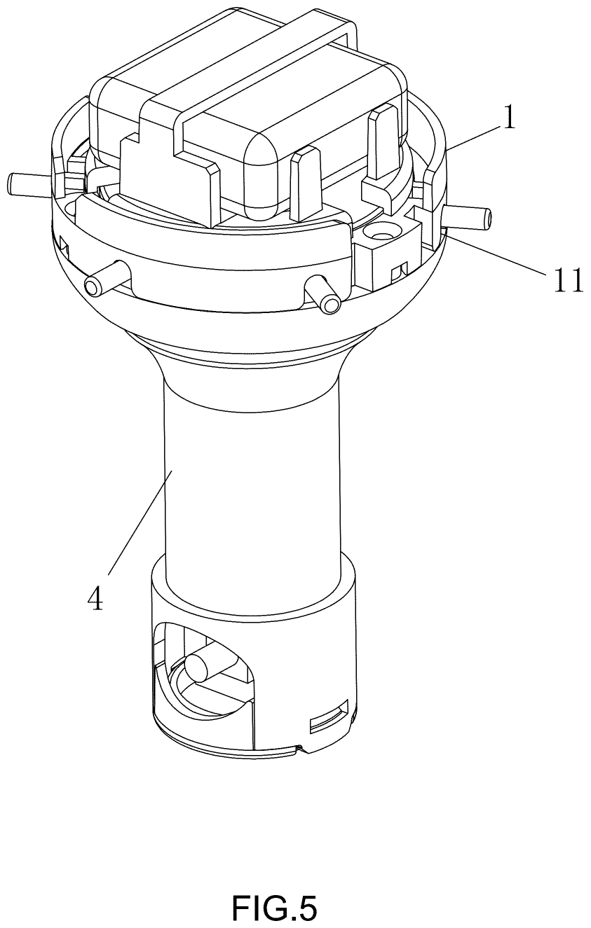

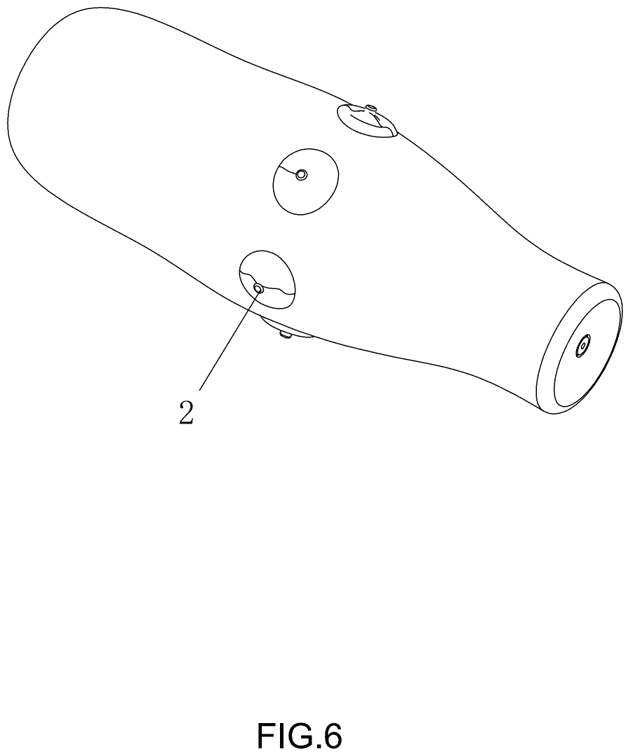

As shown in FIG. 1-7, a circumferential drive mechanism for a massager, comprises:
a housing 1, wherein a plurality of massage heads 2 are disposed along a circumference direction of the housing 1, and the massage heads 2 are slidably installed on the housing 1;
a drive plate 3, wherein the drive plate 3 is provided with a closed-loop non-circular drive groove 31, and the rear end of massage head 2 is slidably installed in the drive groove 31;
and a rotating motor 4, wherein the rotating motor 4 is connected to the drive plate 3, and when the drive plate 3 rotates, the rear end of drive groove 31 and massage head 2 are in contact with the inner wall of drive groove 31 and drive the massage head 2 to move back and forth.

In practical design, a closed-loop non-circular drive groove 31 enables the drive plate 3 to be a simulated cam structure that can simultaneously drive a plurality of massage heads 2 to move back and forth, thereby simultaneously driving a plurality of massage heads 2, and the simple and stable structure and ingenious design (without springs and other structures) effectively improve the stability of the mechanism.

Specifically, the massage head 2 comprises a rod body 2a and a drive head 2b located at the rear end of rod body 2a, and the drive head 2b is snap-fitted in the drive groove 31.

In the embodiment of present disclosure, the housing 1 is a hollow frame in which the drive plate 3 is located;
a guide hole 11 that runs through the outer peripheral wall of housing 1 is provided, and the massage head 2 is slidably installed in the guide hole 11; and
a massage head 2, housing 2, and drive plate 3 are all horizontally arranged. When massage heads 2 are disposed on the outer peripheral wall of the housing 1, the massage head 2, the housing 1, and the drive plate 3 are all horizontally arranged such that the massage heads 2 are axially distributed to perform radial movement.

Specifically, the drive head 2b has a greater diameter than the rod body 2a, the outer circumference of the drive plate 3 away from the drive groove is a guide groove 31 that runs through, and the width of the guide groove 32 is smaller than the minimum diameter of the drive head 2b, enabling the fit between the massage head 2 and drive plate 3.

In the embodiment of present disclosure, the drive head 2b is circular in shape, providing smoother driving effect.

Specifically, the drive groove 31 is elliptical in shape.

The rotating motor is vertically arranged, the rotating motor 4 is vertically arranged, and the drive end of rotating motor 4 is connected to the lower wall of the drive plate 3. Preferably, the drive end is in a cross shape that facilitates locking.

Specifically, the drive plate 3 comprises a lower plate 3b, and an upper plate 3a that is detachably installed on the lower plate 3b, the lower plate 3b and upper plate 3a are provided with a first half groove 3c and a second half groove 3d, respectively, and the first half groove 3 c and second half groove 3d form a drive groove 31.

In the embodiment of present disclosure, the upper wall of the housing 1 is provided with a bracket 5, and the bracket 5 is provided with a lithium battery 51 connected to the rotating motor 4, such that the overall structure of the massager is effectively reduced and reasonably laid out, and preferably, the lithium battery is located between the top wall of the housing and the bracket.

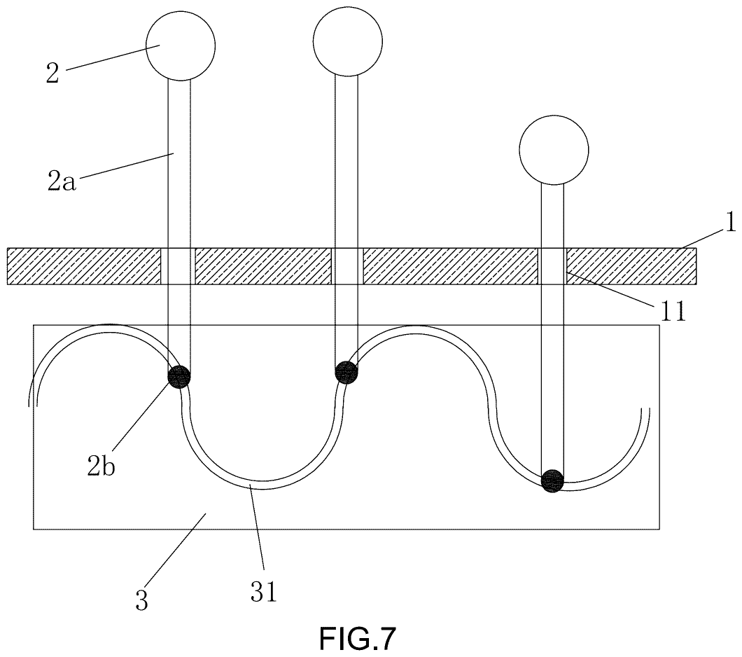

Specifically, the housing 1 has vertically arranged guide holes 11;
the drive groove 31 is vertically arranged and is wave shaped, the rod body 2a is vertically disposed, the drive head 2b is located in the drive groove 31, the massage head 2 swings back and forth along a height direction of the housing 1. In the second embodiment (as shown in FIG. 7), massage head 2 can also be disposed at the upper end to perform reciprocating motion, and the drive plate 3 is located at the lower position of the housing 1, and slotting on the side allows for both driving and vertical movement.

The above are only the preferred embodiments of the present disclosure, and are not intended to limit the present disclosure. Any equivalent structural transformation made based on the description and accompanying drawings hereof under the concept of present disclosure, or be directly/indirectly applied in other related technical fields, should fall within scope of patent protection of the present disclosure.

What is claimed is:

1. A circumferential drive mechanism for massagers, comprises
a housing, wherein a plurality of massage heads are disposed along a circumference direction of the housing, and the massage heads are slidably installed on the housing;
a drive plate, wherein the drive plate is provided with a closed-loop non-circular drive groove, and the rear end of massage head is slidably installed in the drive groove;
and a rotating motor, wherein the rotating motor is connected to the drive plate, and when the drive plate rotates, the rear end of drive groove and massage head are in contact with the inner wall of drive groove and drive the massage head to move back and forth.

2. The circumferential drive mechanism for a massager according to claim 1, wherein the massage head comprises a rod body and a drive head located at the rear end of rod body, and the drive head is snap-fitted in the drive groove.

3. The circumferential drive mechanism for a massager according to claim 2, wherein the housing is a hollow frame in which the drive plate is located;
a guide hole that runs through the outer peripheral wall of housing is provided, and the massage head is slidably installed in the guide hole; and
a massage head, housing, and drive plate are all horizontally arranged.

4. The circumferential drive mechanism for a massager according to claim 3, wherein the drive head has a greater diameter than the rod body, the outer circumference of the drive plate away from the drive groove is a guide groove that runs through, and the width of the guide groove is smaller than the minimum diameter of the drive head.

5. The circumferential drive mechanism for a massager according to claim 3, wherein the drive head is circular in shape.

6. The circumferential drive mechanism for a massager according to claim 3, wherein the drive groove is elliptical in shape.

7. The circumferential drive mechanism for a massager according to claim 3, wherein the rotating motor is vertically arranged, and the drive end of rotating motor is connected to the lower wall of the drive plate.

8. The circumferential drive mechanism for a massager according to claim 3, wherein the drive plate comprises a lower plate, and an upper plate that is detachably installed on the lower plate, the lower plate and upper plate are provided with a first half groove and a second half groove, respectively, and the first half groove and second half groove form a drive groove.

9. The circumferential drive mechanism for a massager according to claim 3, wherein the upper wall of the housing is provided with a bracket, and the bracket is provided with a lithium battery connected to the rotating motor.

10. The circumferential drive mechanism for a massager according to claim 2, wherein the housing has vertically arranged guide holes;
the drive groove is vertically arranged and is wave shaped, the rod body is vertically disposed, the drive head is located in the drive groove, the massage head swings back and forth along a height direction of the housing, and the drive plate is located at the lower position of the housing.
